(19) United States
(12) Patent Application Publication
(10) Pub. No.: US 2025/0141487 A1
(43) Pub. Date: May 1, 2025

(54) PROTECTIVE CASE

(71) Applicant: SHENZHEN EARY INNOVATION DESIGN CO., LTD, SHENZHEN (CN)

(72) Inventor: SHIWANG ZHOU, SHENZHEN (CN)

(21) Appl. No.: 18/925,040

(22) Filed: Oct. 24, 2024

(30) Foreign Application Priority Data
Oct. 25, 2023 (CN) 202322868980.4
Dec. 14, 2023 (CN) 202323417458.0
May 7, 2024 (CN) 202420972184.7
Jun. 12, 2024 (CN) 202421334373.8

(51) Int. Cl. H04B 1/3888; A45F 5/10; F16M 11/06

(52) U.S. Cl. CPC H04B 1/3888; A45F 5/10; F16M 11/06; A45F 2005/1013; A45F 5/1516

(57) ABSTRACT

A protective case, related to a technical field of accessories for computer, communication, and consumer (3C) electronic products, is provided, including a main body, a connecting strap, and a supporting component. The supporting component is disposed on a rear portion of the main body, a first end portion of the connecting strap is connected to the main body, a second end portion of the connecting strap is rotatably connected to the supporting component, thereby being enclosed to form an accommodating space for fingers of a user to pass through, and since the connecting strap is made by a flexible material, better comfort is provided when the fingers of the user come into contact with the connecting strap, thereby further enabling excellent user experience.

### CROSS-REFERENCE TO RELATED APPLICATIONS

This application is based upon and claims priority to Chinese Patent Application No. 2023228689804, entitled “ELELCTRONIC DEVICE PROTECTIVE CASE” and filed on Oct. 25, 2023, Chinese Patent Application No. 2023234174580, entitled “PROTECTIVE CASE” and filed on Dec. 14, 2023, Chinese Patent Application No. 2024209721847, entitled “PROTECTIVE CASE” and filed on May 7, 2024, and Chinese Patent Application No. 2024213343738, entitled “PROTECTIVE CASE” and filed on Jun. 12, 2024, the entire contents of which are incorporated herein by reference.

### TECHNICAL FIELD

The present disclosure relates to a technical field of accessories for computer, communication, and consumer (3C) electronic products, and in particular to a protective case.

### BACKGROUND

To expand usage function of protective cases, some of current protective cases each is provided with a main body and a supporting component, a corresponding main body is configured to mount on a corresponding mobile terminal, such as a mobile phone, a tablet compute, etc., a corresponding supporting component is capable of rotating with respect to a rear portion of the corresponding main body until supporting the rear portion of the corresponding main body, in this way, such protective cases are enabled to support the corresponding mobile terminal, thereby being popular in the market.

In the prior art, the corresponding supporting component of such protective cases is ring-shaped, so that a space for fingers of a user to pass through is formed after the corresponding supporting component turns around. As a result, even if the user does not firmly hold the corresponding mobile terminal, the corresponding supporting component is still hung by the fingers of the user to prevent the corresponding mobile terminal from falling.

However, since such supporting component is made of hard materials, poorer comfort is result when the fingers of the user come into contact with the corresponding supporting component, which greatly affects user experience.

### SUMMARY

A technical problem to be solved by the present disclosure is to provide a protective case to overcome defects in the prior art that current accessories for computer, communication, and consumer (3C) electronic products are limited in placement position, which cannot satisfy different replacement requirements of a user.

The protective case provided by embodiments of the present disclosure includes a main body, a connecting strap, and a supporting component. The connecting strap is made by a flexible material. The connecting strap includes a first end portion and a second end portion, the first end portion of the connecting strap is disposed opposite to the second end portion of the connecting strap, and the first end portion of the connecting strap is connected to the main body. The supporting component is disposed on a rear portion of the main body, the second end portion of the connecting strap is rotatably connected to the supporting component to enable the connecting strap to enclose to define an accommodating space and to enable the supporting component to rotate with respect to the rear portion of the main body and to support the rear portion of the main body.

Furthermore, the protective case further includes a connecting base, the supporting component is disposed on the rear portion of the main body through the connecting base, the supporting component is rotatably connected to the second end portion of the connecting strap through the connecting base, the connecting base is detachably connected to the rear portion of the main body.

Furthermore, the second end portion of the protective case includes two first connecting sections, the connecting base is clamped between the two first connecting sections.

Furthermore, at least one first through opening is defined on the connecting base, the second end portion of the connecting strap further includes at least one connecting rib, the at least one connecting rib passes through the at least one through opening and is connected to the two first connecting sections.

Furthermore, the protective case further includes a mounting block, the first end portion of the connecting strap is connected to the mounting block, a groove is defined on one side of the main body facing opposite to the rear portion of the main body, a first opening is defined on a bottom of the groove. The mounting block includes a first mounting portion and at least one inserting portion, a contour of the first mounting portion is matched with a contour of the groove, and the contour of the first mounting portion is greater than a contour of the first opening, so that the first mounting portion is clamped at the groove. The at least one inserting portion is connected to one side of the first mounting portion facing the first opening, the at least one inserting portion defines a first inserting groove at a portion thereof where the portion of the at least one inserting portion protrudes out of the first opening, and the first inserting groove allows the connecting base to insert.

Furthermore, a width of the mounting block is less than a diagonal length of the first opening, and a width of the supporting component is greater than the diagonal length of the first opening.

Furthermore, the protective case further includes a slot structure and an inserting structure, one of the slot structure and the inserting structure is disposed on the rear portion of the main body, and another one of the slot structure and the inserting structure are disposed on the connecting base. The inserting structure is inserted into the slot structure in a first direction for detachably connecting the connecting base to the rear portion of the main body.

Furthermore, the protective case further includes a first positioning friction block, the connecting base includes a first surface perpendicular to a second direction, the second direction is perpendicular to the first direction. The first positioning friction block is disposed on the first surface and is configured to provide a positioning friction force when the inserting structure is inserted into the slot structure.

Furthermore, the inserting structure is disposed on the rear portion of the main body, the inserting structure includes two inserting blocks extending in the first direction, the two inserting blocks are spaced apart in a third direction, the first end portion of the connecting strap is disposed between the two inserting blocks, the third direction is perpendicular to the first direction and the second direction. The slot structure includes two form-fitting slots respectively matched with the two inserting blocks, a first mounting groove is further defined on the first surface, the first mounting groove is defined between the two form-fitting slots, the first positioning friction block is disposed in the first mounting groove, so that the first positioning friction block is disposed opposite to the first end portion of the connecting strap in the second direction.

Furthermore, the connecting base includes a first hard connecting block and a second hard connecting block, the first hard connecting block is connected with the second hard connecting block, the second end portion of the connecting strap is clamped between the first hard connecting block and the second hard connecting block.

Furthermore, the protective case further includes a first protruding portion and a first recessed portion, one of the first protruding portion and the first recessed portion is disposed on one side of the first hard connecting block facing the second end portion of the connecting strap, another one of the first protruding portion and the first recessed portion is disposed on a first side of the second end portion of the connecting strap facing the first hard connecting block, the first protruding portion is configured to accommodate into the first recessed portion; and/or, the protective case further includes a second protruding portion and a second recessed portion, one of the second protruding portion and the second recessed portion is disposed on one side of the second hard connecting portion facing the second end portion of the connecting strap, another one of the second protruding portion and the second recessed portion is disposed on a second side of the second end portion of the connecting strap facing the second hard connecting block, the second protruding portion is configured to accommodate into the second recessed portion.

Furthermore, a second inserting groove is defined on the rear portion of the main body for allowing the connecting base to insert.

Furthermore, the protective case further includes at least one elastic clamping block and at least one clamping groove, one of the at least one elastic clamping block and the at least one clamping groove is disposed on a groove wall of the second inserting groove, and another one of the at least one elastic clamping block and the at least one clamping groove is disposed on the connecting base, the at least one elastic clamping block is matched with the at least one clamping groove; and/or, a second positioning friction block is disposed on the groove wall of the second inserting groove, and the second positioning friction block is configured to abut against the connecting base.

Furthermore, the at least one elastic clamping block includes two side walls oppositely disposed along a groove opening of the second inserting groove, and the two side walls gradually come closer in a direction where the at least one elastic clamping block faces a groove bottom of the at least one clamping groove.

Furthermore, the connecting base further includes at least one screw, at least one inner threaded column is disposed on one side of the first hard connecting block facing the second hard connecting block, the at least one inner threaded column passes through the second end portion of the connecting strap, at least one mounting hole is defined on the second hard connecting bock, and the at least one screw passes through the at least one mounting hole and the at least one inner threaded column for fixedly connecting the first hard connecting block and the second hard connecting block.

Furthermore, an orientation of the groove opening of the second inserting groove is perpendicular to a thickness direction of the main body. A second through opening is defined at a groove bottom of the second inserting groove for the connecting strap to pass through.

Furthermore, the second through opening includes a first area and a second area, the first area is disposed at one side of the second area close to the rear portion of the main body. A first middle portion of the connecting strap adjacent to the second end portion of the connecting strap passes through the second area, a limiting step is disposed at a second middle portion of the connecting strap adjacent to the first end portion of the connecting strap, the limiting step is disposed at the first area and is configured to limit the connecting base.

Furthermore, the protective case further includes a connecting assembly, the connecting assembly is disposed on the rear portion of the main body, the connecting assembly includes a third hard connecting block and a fourth hard connecting block, the third hard connecting block is connected with the fourth connecting block, and the first end portion of the connecting strap is clamped between the third hard connecting block and the fourth hard connecting block.

Furthermore, a first magnetic ring is disposed on the supporting component, a second magnetic ring is disposed on the rear portion of the main body, and the first magnetic ring is attracted to the second magnetic ring.

Furthermore, the protective case further includes a reflective mirror, the reflective mirror is disposed on one side of the supporting component facing the rear portion of the main body.

Compared with the prior art, beneficial effects of the embodiments of the present disclosure are as follows.

The protective case of the embodiments of the present disclosure includes the main body, the connecting strap, and the supporting component, the supporting component is disposed on the rear portion of the main body, the first end portion of the connecting strap is connected to the main body, the second end portion of the connecting strap is rotatably connected to the supporting component, thereby being enclosed to form the accommodating space for fingers of the user to pass through, and since the connecting strap is made by the flexible material, better comfort is provided when the fingers of the user come into contact with the connecting strap, thereby further enabling excellent user experience.

### BRIEF DESCRIPTION OF DRAWINGS

Specific embodiments of the present disclosure are further described in detail below with reference to accompanying drawings, in the accompanying drawing:

FIG. 1 is a structural schematic diagram of a protective case according to a first embodiment of the present disclosure.

FIG. 2 is a schematic diagram of the protective case shown in FIG. 1 where the protective case is in a first configuration of use.

FIG. 3 is a schematic diagram of the protective case shown in FIG. 2 where the protective case is in a second configuration of use.

FIG. 4 is a first structural schematic diagram of the protective case according to a second embodiment of the present disclosure.

FIG. 5 is a structural schematic diagram of the protective case shown in FIG. 4 removing a main body.

FIG. 6 is a schematic diagram of the protective case shown in FIG. 4 where the protective case is in a first configuration of use.

FIG. 7 is a structural schematic diagram of a connecting base of the protective case shown in FIG. 4.

FIG. 8 is a structural schematic diagram of a second end portion of a connecting strap of the protective case shown in FIG. 4.

FIG. 9 is another structural schematic diagram of the protective case removing the main body shown in FIG. 5.

FIG. 10 is a second structural schematic diagram of the protective case shown in FIG. 4.

FIG. 11 is an enlarged schematic diagram of portion A shown in FIG. 10.

FIG. 12 is a structural schematic diagram of a connecting assembly of the protective case shown in FIG. 4.

FIG. 13 is a structural schematic diagram of the protective case according to a third embodiment of the present disclosure.

FIG. 14 is a schematic diagram of the protective case shown in FIG. 13 where the protective case is in a configuration of use.

FIG. 15 is an enlarged schematic diagram of portion B shown in FIG. 14.

FIG. 16 is an enlarged schematic diagram of portion C shown in FIG. 14.

FIG. 17 is a structural schematic diagram of the protective case according a fourth embodiment of the present disclosure.

FIG. 18 is a schematic diagram of the protective case shown in FIG. 17 where the protective case is in a configuration of use.

FIG. 19 is an enlarged schematic diagram of portion D shown in FIG. 18.

FIG. 20 is an enlarged schematic diagram of portion E shown in FIG. 18.

FIG. 21 is a structural schematic diagram of the connecting base of the protective case shown in FIG. 13.

FIG. 22 is another structural schematic diagram of the connecting base of the protective case shown in FIG. 21.

FIG. 23 is a structural schematic diagram of the connecting strap of the protective case shown in FIG. 13.

FIG. 24 is a structural schematic diagram of the protective case according a fifth embodiment of the present disclosure.

FIG. 25 is a schematic diagram of the protective case shown in FIG. 24 where the protective case is in a configuration of use.

FIG. 26 is an exploded schematic diagram of the second end portion of the connecting strap, a first hard connecting block, a second hard connecting block of the protective case shown in FIG. 24.

FIG. 27 is another exploded schematic diagram of the second end portion of the connecting strap, the first hard connecting block, the second hard connecting block of the protective case shown in FIG. 26.

FIG. 28 is an enlarged schematic diagram of portion N shown in FIG. 25.

FIG. 29 is an enlarged schematic diagram of portion M shown in FIG. 25.

FIG. 30 is an exploded schematic diagram of a third hard connecting block and an elastic clamping block of the protective case shown in FIG. 24.

FIG. 31 is another structural schematic diagram of the protective case shown in FIG. 24.

FIG. 32 is a simplified structural schematic diagram of an embedded block and a spring of the present disclosure.

FIG. 33 is a structural schematic diagram of the connecting strap of the protective case shown in FIG. 24.

FIG. 34 is a structural schematic diagram of a screw of the present disclosure.

FIG. 35 is a structural schematic diagram of the protective case according to a sixth embodiment of the present disclosure.

Reference numerals in the drawings: 1000. main body; 100. connecting strap; 110. rear portion; 120. groove; 121. bottom of the groove; 130. first opening; 120. first magnetic ring; 200. connecting strap; 210. first end portion; 220. second end portion; 221. first connecting section; 222. connecting rib; 223. hard pin; 224. first recessed portion; 225. second protruding portion; 226. anti-slip protrusion; 230. accommodating space; 240. second positioning friction block; 250. limiting step; 300. supporting component; 310. first magnetic ring; 320. third mounting groove; 400. connecting base; 410. first through opening; 420. first surface; 421. first mounting groove; 430. second surface; 431. inserting hole; 440. first hard connecting block; 441. first protruding portion; 442. inner threaded column; 450. second hard connecting block; 451. second recessed portion; 452. mounting hole; 460. clamping groove; 461. groove bottom of the clamping groove; 470. screw; 500. mounting groove; 510. first mounting portion; 520. inserting portion; 521. first inserting groove; 610. slot structure; 611. form-fitting slots; 612. protruding block; 620. inserting structure; 621. inserting block; 622. inserting edge; 700. first positioning friction block; 800. connecting assembly; 810. third hard connecting block; 811. second inserting groove; 8111. groove wall of the second inserting groove; 81111. second opening; 8112. opening of the second inserting groove; 8113. groove bottom of the second inserting groove; 81121. second through opening; 811211. first area; 811212. second area; 812. second mounting groove; 820. fourth hard connecting block; 830. elastic clamping block; 831. side wall; 832. second mounting portion; 833. clamping portion; 834. embedded block; 835. spring; 900. reflective mirror.

### DETAILED DESCRIPTION OF EMBODIMENTS

It should be noted that, in the case of no conflict, embodiments in the present disclosure and features in the embodiments may be combined with each other. The preferred embodiments of the present disclosure are described in detail with reference to the accompanying drawings.

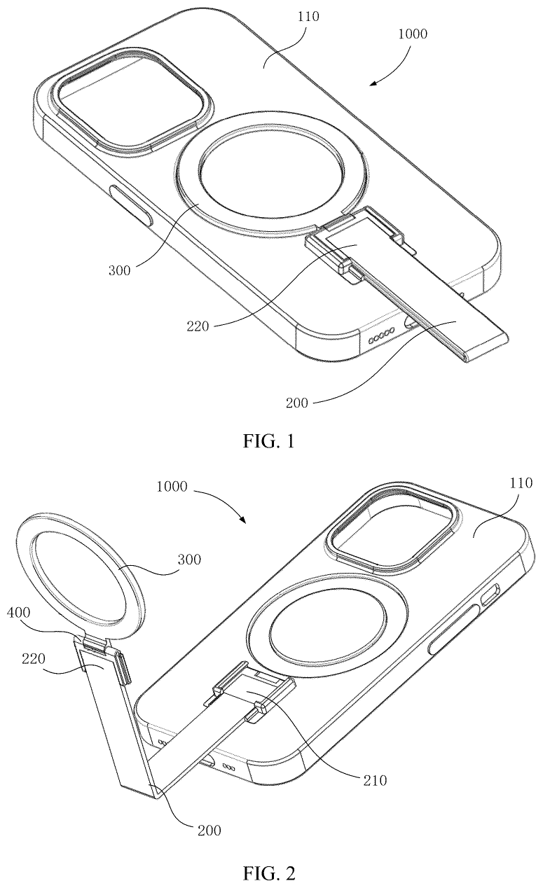

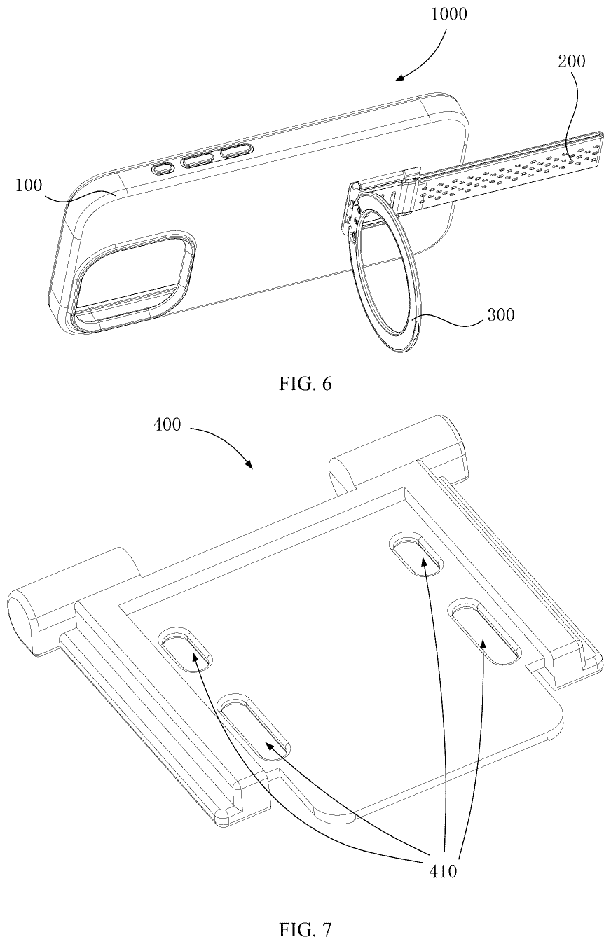

The embodiments of the present disclosure provide a protective case, as shown in FIGS. 1-6, the protective case 1000 includes a main body 100, a connecting strap 200, and a supporting component 300. The connecting strap 200 is made by a flexible material. The connecting strap 200 includes a first end portion 210 and a second end portion 220, the first end portion 210 of the connecting strap 200 is disposed opposite to the second end portion 220 of the connecting strap 200, and the first end portion 210 of the connecting strap 200 is connected to the main body 100. The supporting component 300 is disposed on a rear portion 110 of the main body 100, the second end portion 220 of the connecting strap 200 is rotatably connected to the supporting component 300 to enable the connecting strap 200 to enclose to define an accommodating space 230 and to enable the supporting component 300 to rotate with respect to the rear portion 110 of the main body 100 and to support the rear portion 100 of the main body 100.

The protective case 1000 of the embodiments is provided with the supporting component 300, and the supporting component 300 is capable of rotating with respect to the main body 100 and supporting the rear portion 110 of the main body 100, so that the protective case 1000 is capable of serving as a support, thereby freeing both hands of a user, in this way, user experience of the protective case 1000 is excellent.

Specifically, the first end portion 210 of the connecting strap 200 is connected to the main body 100 and the second end portion 220 of the connecting strap 200 is rotatably connected to the supporting component 300 to form the accommodating space 230 for fingers of the user to pass through, in this way, even if the user does not firmly hold a mobile terminal, the connecting strap 200 is still hung by the fingers of the user to prevent the mobile terminal from falling. Moreover, since the connecting strap 200 is made by the flexible material, better comfort is provided when the fingers of the user come into contact with the connecting strap 200, thereby further enabling excellent user experience. Certainly, it can be understood that the accommodating space 230 formed by enclosing the connecting strap 200 may also be used for a hook or other hanging components to pass through, so as to hang the mobile terminal.

It should be noted that the flexible materials is selected from, but not limited to, silica gel and rubber.

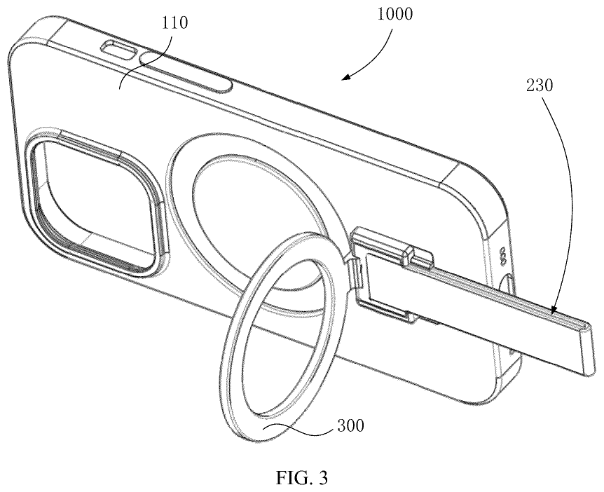

Referring to FIGS. 2-7, in one embodiment, the protective case 1000 further includes a connecting base 400, the supporting component 300 is disposed on the rear portion 110 of the main body 100 through the connecting base 400, the supporting component 300 is rotatably connected to the second end portion 220 of the connecting strap 200 through the connecting base 400, the connecting base 400 is detachably connected to the rear portion 110 of the main body 100.

Specifically, since the supporting component 300 is disposed on the rear portion 110 of the main body 100 through the connecting base 400, and the connecting base 400 is detachably connected to the rear portion 110 of the main body 100, the supporting component 300 is capable of being removed from the rear portion 110 of the main body 100.

As an example, in a usage scenario of wireless charging, the closer a wireless charger is to the mobile terminal, the higher charging efficiency, since the supporting component 300 protrudes from the rear portion 110 of the main body 100, use of the supporting component 300 causes the wireless charger to become farther away from the mobile terminal when in use, resulting in low charging efficiency. By implementing the embodiment, the supporting component 300 is capable of being removed from the rear portion 110 of the main body 100 during wireless charging, so that the supporting component 300 does not affect a speed of wireless charging.

Moreover, it should be noted that, even if the supporting component 300 is removed from the rear portion 110 of the main body 100, since the first end portion 210 of the connection strap 200 is still connected to the main body 100, the supporting component 300 and the main body 100 are not completely separated, in this way, the supporting component 300 is avoided from being carelessly lost after being removed from the rear portion 110 of the main body 100.

In some embodiments, the second end portion 220 of the connecting strap 200 is injection molded onto the connecting base 400. In this way, independent connection structures, such as glue and double-sided adhesive, are not needed between the second end portion 220 of the connecting strap 200 and the connecting base 400, which saves production and assembly costs and enables relatively reliable connection.

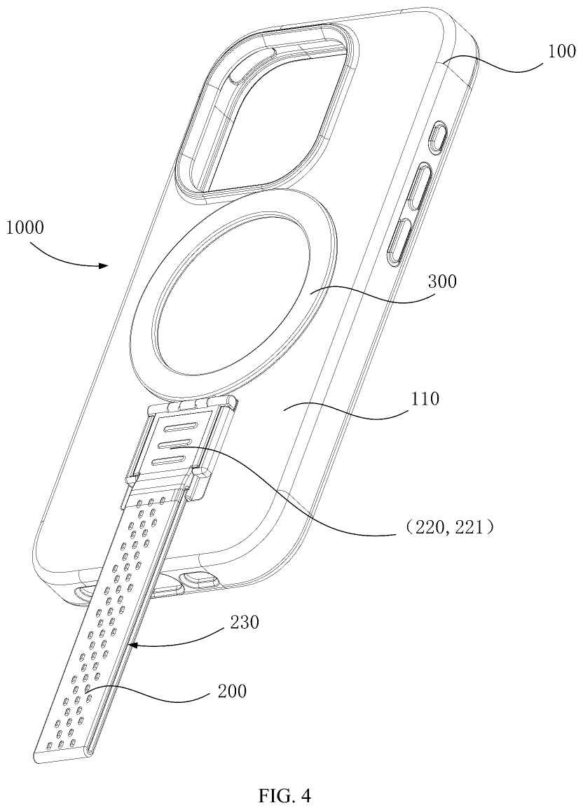

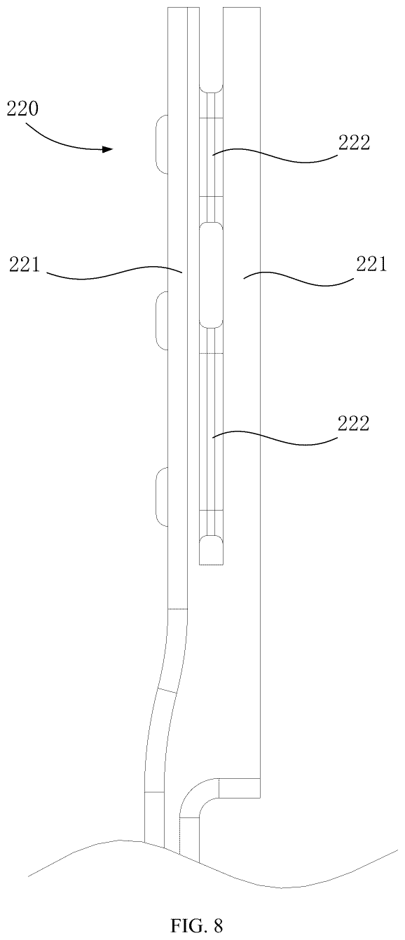

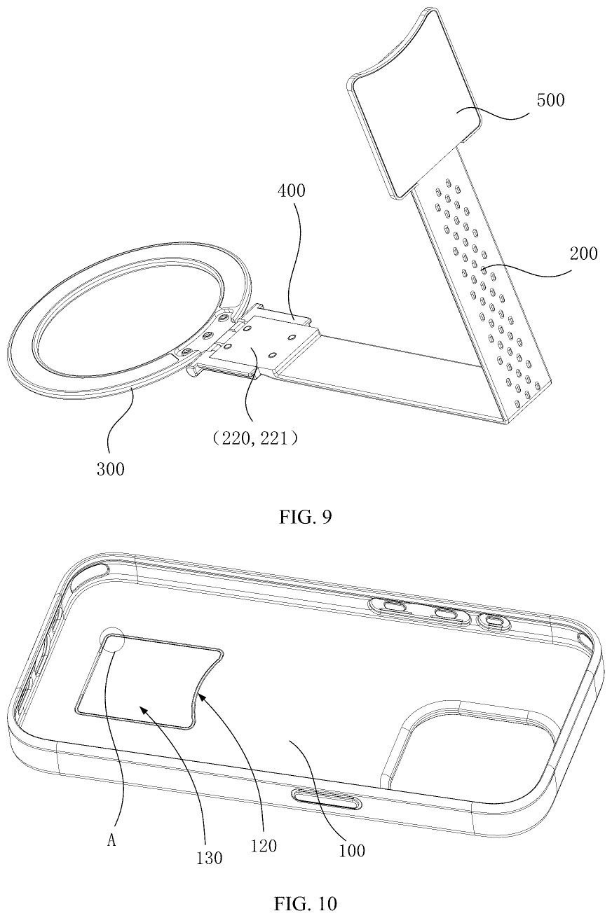

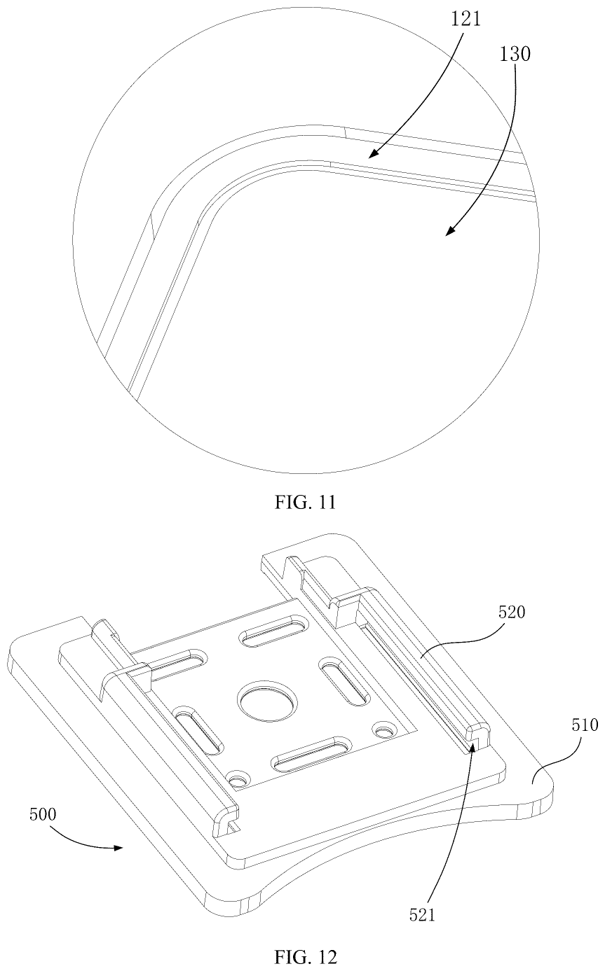

Please refer to FIGS. 4-8, in a specific embodiment, the second end portion 220 of the protective case 200 includes two first connecting sections 221, the connecting base 400 is clamped between the two first connecting sections 221.

Specifically, compared with the embodiment in which the second end portion 220 of the connecting strap 200 is only connected to one side of the connecting base 400, a connection area between the second end portion 220 of the connecting strap 200 and the connecting base 400 is larger, and connection reliability between the second end portion 220 of the connecting strap 200 and the connecting base 400 is higher, which effectively prevents the user from damaging the second end portion 200 of the connecting strap 200 when pulling the connecting strap 200.

Referring to FIGS. 4-8, in a specific embodiment, at least one first through opening 410 is defined on the connecting base 400, the second end portion 220 of the connecting strap 200 further includes at least one connecting rib 222, the at least one connecting rib 222 passes through the at least one through opening 410 and is connected to the two first connecting sections 221.

By implementing the embodiment, the connection area between the second end portion 220 of the connecting strap 200 and the connecting base 400 and the connection reliability between the second end portion 220 of the connecting strap 200 and the connecting base 400 are further increased, a restraining force between the two first connecting sections 221 is also increased, which effectively prevents the user from damaging the second end portion 200 of the connecting strap 200 when pulling the connecting strap 200.

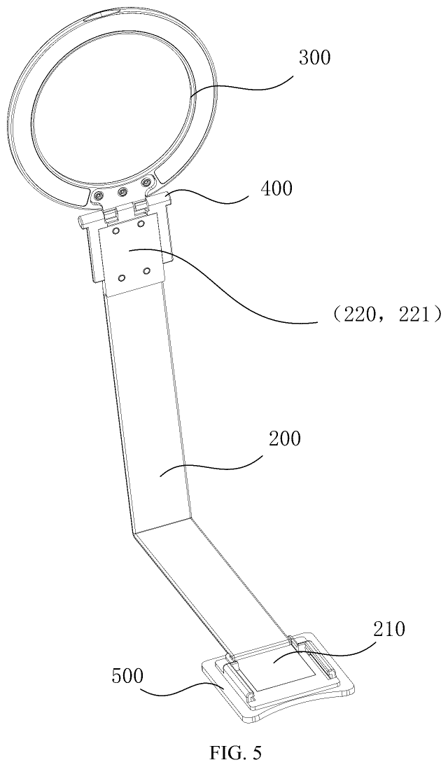

Referring FIGS. 5 and 12, in some embodiments, the protective case 1000 further includes a mounting block 500, the first end portion 210 of the connecting strap 200 is connected to the mounting block 500, a groove 120 is defined on one side of the main body 100 facing opposite to the rear portion 110 of the main body 100, a first opening 130 is defined on a bottom 121 of the groove 120. The mounting block 500 includes a first mounting portion 510 and at least one inserting portion 520, a contour of the first mounting portion 510 is matched with a contour of the groove 120, and the contour of the first mounting portion 510 is greater than a contour of the first opening 130, so that the first mounting portion 510 is clamped at the groove 120. The at least one inserting portion 520 is connected to one side of the first mounting portion 510 facing the first opening 130, the at least one inserting portion 520 defines a first inserting groove 521 at a portion thereof where the portion of the at least one inserting portion 520 protrudes out of the first opening 130, and the first inserting groove 521 allows the connecting base 400 to insert.

By implementing the embodiment, after the mounting block 500 is assembled, the first mounting portion 510 is clamped at the groove 120 and is limited by the bottom 121 of the groove 120, even if the user pulls the connecting strap 200, the mounting block 500 does not loosen. Furthermore, a glue layer is disposed between the first mounting portion 510 and the groove 120 to improve connection stability between the mounting block 500 and the main body 100. The embodiment provides a specific implementation in which the connecting base 400 is detachably connected to the rear portion 110 of the main body 100, specifically, when the connecting base 400 is detached from the rear portion 110 of the main body 100, the connecting base 400 is pulled out of the first inserting groove 521, and it is only necessary to insert the connecting base 400 into the first inserting groove 521 to mount the connecting base 400 back to the rear portion 110 of the main body 100, which is very convenient.

In a specific embodiment, a width of the mounting block 500 is less than a diagonal length of the first opening 130, and a width of the supporting component 300 is greater than the diagonal length of the first opening 130.

Specifically, if the width of the supporting component 300 is less than the diagonal length of the first opening 130, a volume of the supporting component 300 is small, so that support stability of the supporting component 300 is relatively poor. In order to ensure the support stability of the supporting component 300, the width of the supporting component 300 in the embodiment is greater than the diagonal length of the first opening 130. Since the supporting component 300 cannot pass through the first opening 130, for convenience of assembly, in the embodiment, the width of the mounting block 500 is less than the diagonal length of the first opening 130, so that the mounting block 500 is capable of inserting into the first opening 130 from the rear portion 110 of the main body 100 during assembly, which is very convenient.

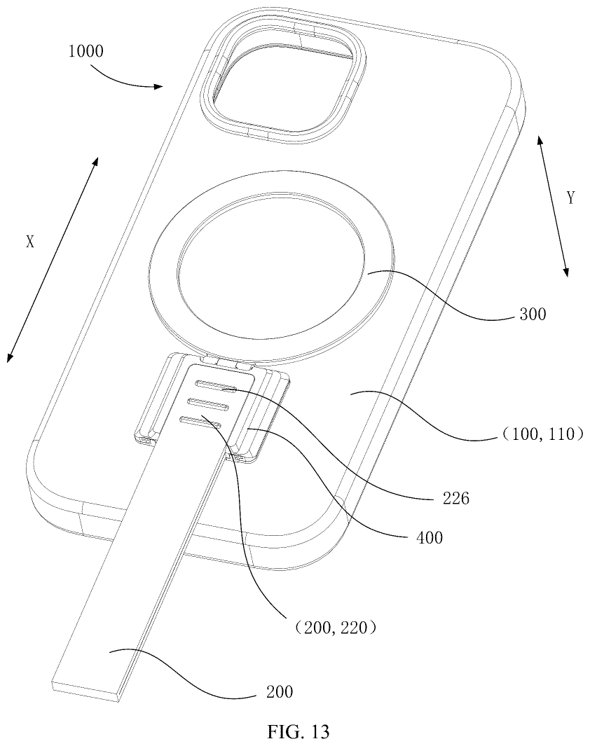

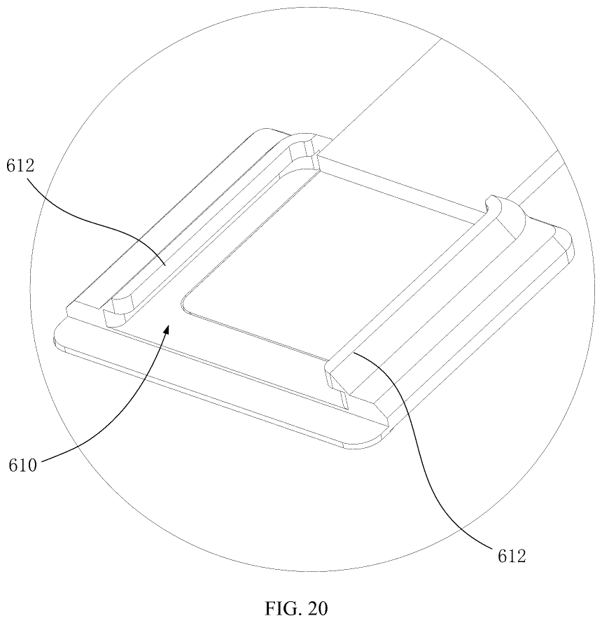

Referring to FIGS. 13-20, in some embodiments, the protective case 1000 further includes a slot structure 610 and an inserting structure 620, one of the slot structure 610 and the inserting structure 620 is disposed on the rear portion 110 of the main body 100, and another one of the slot structure 610 and the inserting structure 620 are disposed on the connecting base 400. The inserting structure 620 is inserted into the slot structure 610 in a first direction (X direction shown in FIG. 13) for detachably connecting the connecting base 400 to the main body 100.

The embodiment provides a specific implementation where the connecting base 400 is detachably connected to the rear portion 110 of the main body 100, specifically, when the connecting base 400 is detached from the rear portion 110 of the main body 100, the inserting structure 620 is pulled out of the slot structure 610, and it is only necessary to insert the inserting structure 620 back into the slot structure 610 to mount the connecting base 400 back to the rear portion 110 of the main body 100.

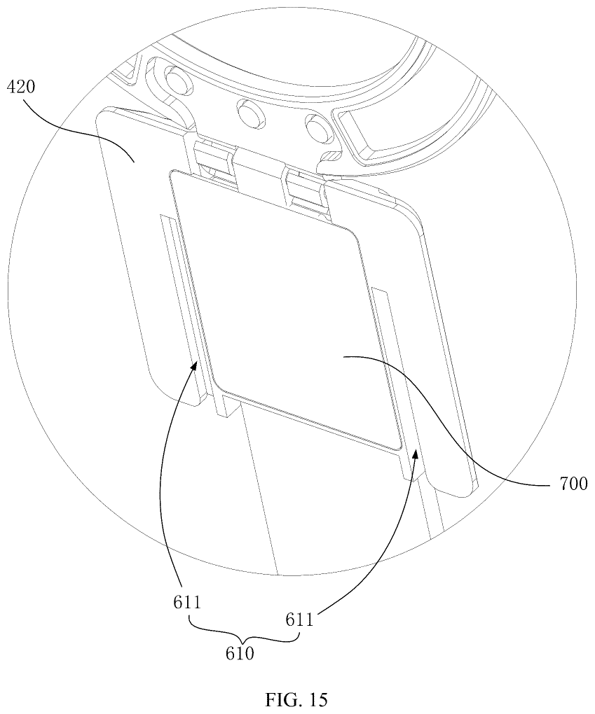

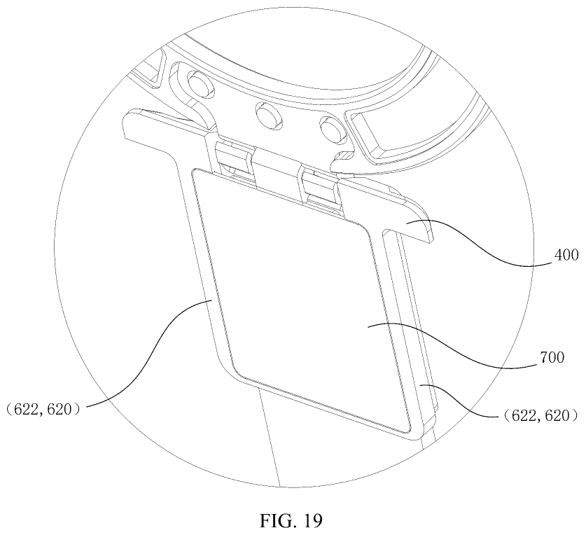

Referring to FIGS. 15 and 19, in some embodiments, the protective case 1000 further includes a first positioning friction block 700, the connecting base 400 includes a first surface 420 perpendicular to a second direction (Y direction shown in FIG. 13), the second direction is perpendicular to the first direction. The first positioning friction block 700 is disposed on the first surface 420 and is configured to provide a positioning friction force when the inserting structure 620 is inserted into the slot structure 610.

It should be noted that, since the connecting base 400 is capable of being detached from the rear portion 110 of the main body 100 and move with respect to the main body 100, definition of the second direction may be unclear herein, and in order to clearly define the second direction, the second direction referred to in the embodiment is determined based on a state where the connecting base 400 is mounted on the rear portion 110 of the main body 100.

Specifically, the inserting structure 620 is inserted into the slot structure 610 in the first direction, and the first positioning friction block 700 is disposed on the connecting base 400 along the second direction, an arrangement direction of the first positioning friction block 700 with respect to the connecting base 400 is inconsistent with an inserting direction of the inserting structure 620 with respect to the slot structure 610, so that the first positioning friction block 700 is capable of providing the positioning friction force when the inserting structure 620 is inserted into the slot structure 610, in this way, the inserting structure 620 cannot be easily separated from the slot structure 610, thereby improving the user experience.

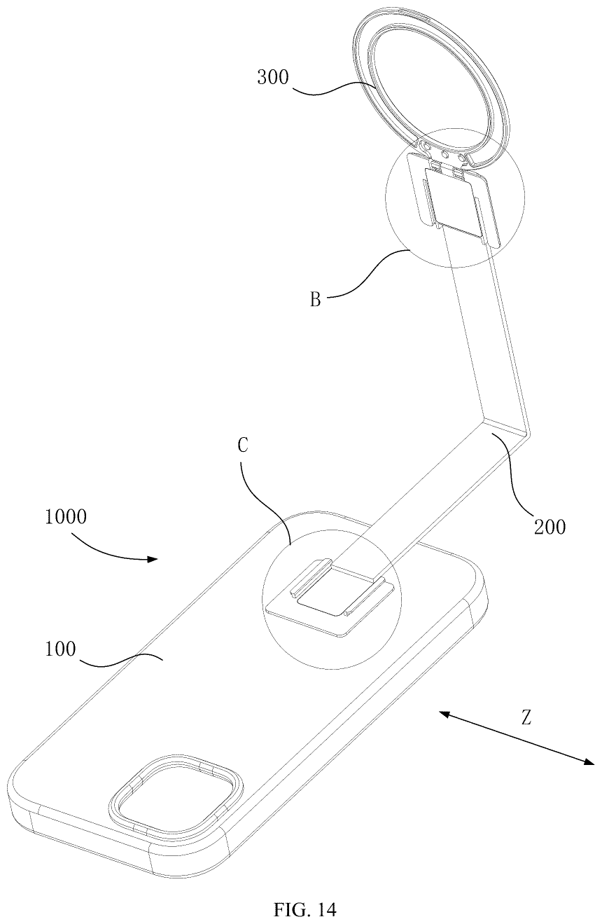

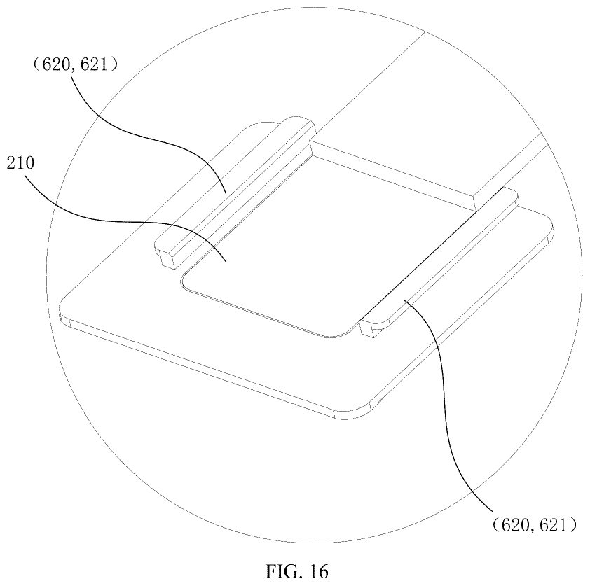

Referring to FIGS. 15-16, in some embodiments, the inserting structure 620 is disposed on the rear portion 110 of the main body 100, the inserting structure 620 includes two inserting blocks 621 extending in the first direction, the two inserting blocks 621 are spaced apart in a third direction (Z direction shown in FIG. 14), the first end portion 210 of the connecting strap 200 is disposed between the two inserting blocks 621, the third direction is perpendicular to the first direction and the second direction. The slot structure 610 includes two form-fitting slots 611 respectively matched with the two inserting blocks 621.

By implementing the embodiment, when the connecting base 400 is mounted on the rear portion 110 of the main body 100, the first end portion 210 of the connecting strap 200 is shielded by the connecting base 400, compared with the embodiment in which the first end portion 210 of the connecting strap 200 is exposed to the protective case 1000, an appearance of the protective case 1000 is effectively improved.

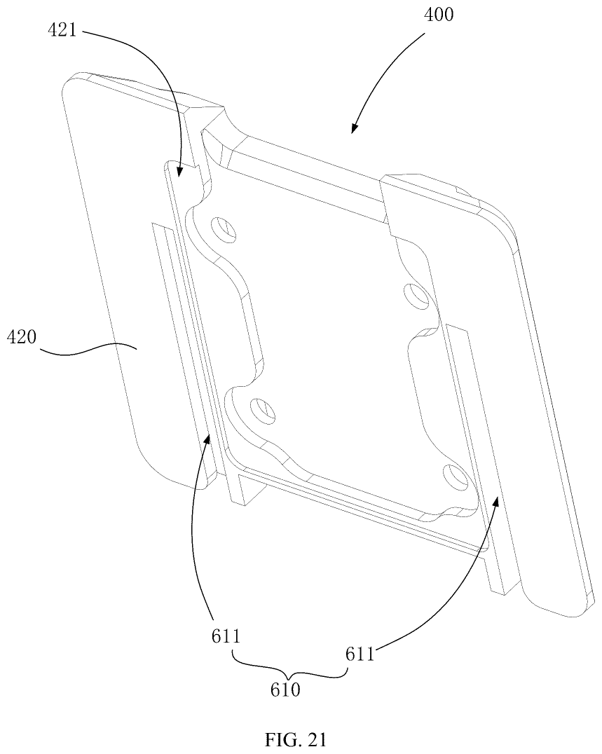

Referring to FIGS. 1 and 21, in a specific embodiment, a first mounting groove 421 is further defined on the first surface 420, the first mounting groove 421 is defined between the two form-fitting slots 611, the first positioning friction block 700 is disposed in the first mounting groove 421, so that the first positioning friction block 700 is disposed opposite to the first end portion 210 of the connecting strap 200 in the second direction, in this way, the first positioning friction block 700 cooperates with the first end portion 210 of the connecting strap 200 to provide the positioning friction force.

Specifically, a purpose of providing the first mounting groove 421 is to provide a specific mounting position for the first positioning friction block 700, and when the first mounting groove 421 is not provided, the first positioning friction block 700 is easy to tilt, so that the first positioning friction block 700 deviates from a preset mounting position, and if deviation of the first positioning friction block 700 is too large, the positioning friction force is insufficient. In order to solve such technical problem, in the embodiment, the first mounting groove 421 is defined between the two form-fitting slots 611 and the first positioning friction block 700 is disposed in the first mounting groove 421, so that the first positioning friction block 700 is prevented from tilting.

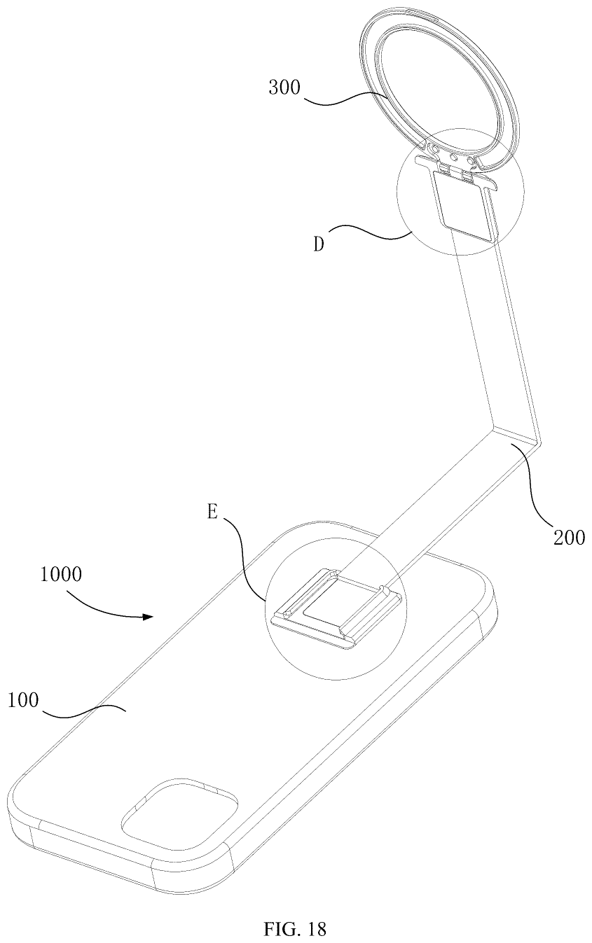

Referring to FIGS. 18-20, in some embodiments, two protruding blocks 612 extending in the first direction are disposed on the rear portion 110 of the main body 100, and the two protruding blocks 612 are spaced apart to form the slot structure 610 therebetween, the first end portion 210 of the connecting strap 200 is disposed between the two protruding blocks 612. The inserting structure 620 includes two inserting edges 622 disposed on two sides of the connecting base 400, and the two edges 622 on the two sides of the connecting base 400 are respectively matched with and respectively cooperate with the two protruding blocks 612.

By implementing the embodiment, when the connecting base 400 is mounted on the rear portion 110 of the main body 100, the first end portion 210 of the connecting strap 200 is shielded by the connecting base 400, compared with the embodiment in which the first end portion 210 of the connecting strap 200 is exposed to the protective case 1000, the appearance of the protective case 1000 is effectively improved.

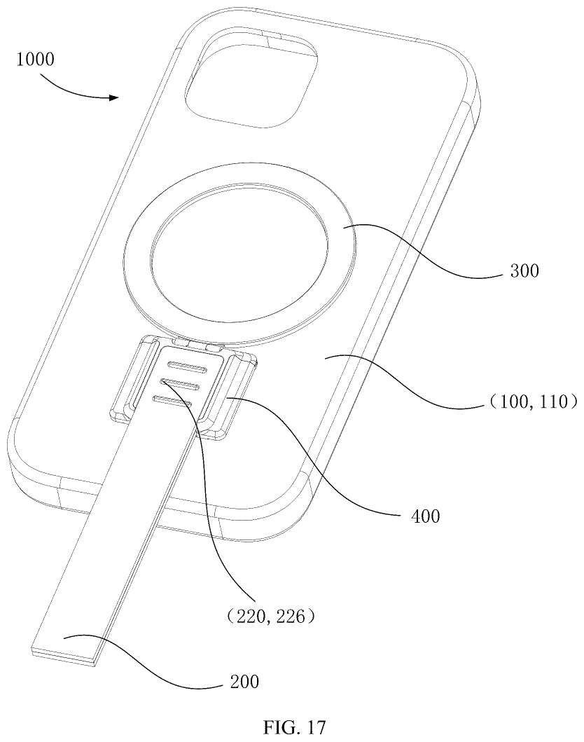

Referring to FIGS. 13 and 17, in some embodiments, at least one anti-slip protrusion 226 is disposed on one side of the second end portion 220 of the connecting strap 200 facing the first surface 420.

Specifically, the at least one anti-slip protrusion 226 is configured to increase a friction force when the user pushes out the connecting base 400, so that the user may more easily apply forces to the connecting base 400, thereby enabling better user experience. A specific shape of the at least one anti-slip protrusion 226 is selected from, but not limited to, a convex strip shape and a convex dot shape.

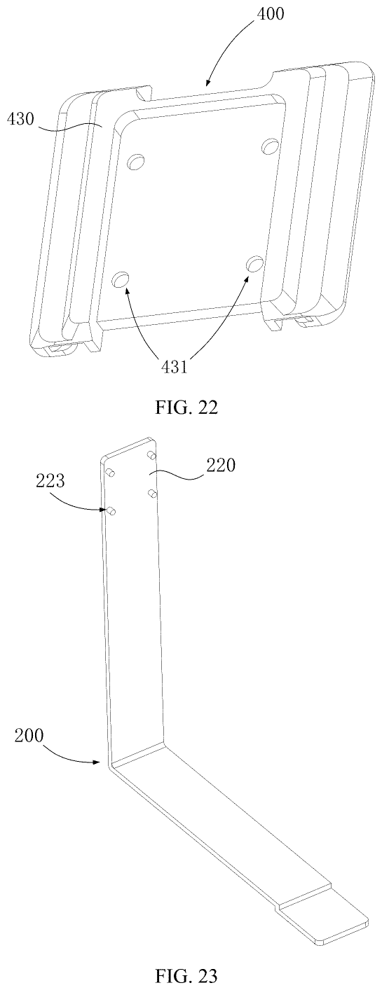

Referring to FIGS. 22-23, in some embodiments, the second end portion 220 of the connecting strap 200 includes a second surface 430 disposed facing opposite to the first surface 420, at least one hard pin 223 is disposed on one side of the second end portion 220 of the connecting strap 200 facing the second surface 430, at least one inserting hole 431 is defined on the second surface 430, and the at least one hard pin 223 is mounted in the at least one inserting hole 431.

Specifically, since the at least one hard pin 223 is hard in texture, connection stability between the second end portion 220 of the connecting strap 200 and the connecting base 400 is improved by cooperation between the at least one hard pin 223 and the at least one inserting hole 431.

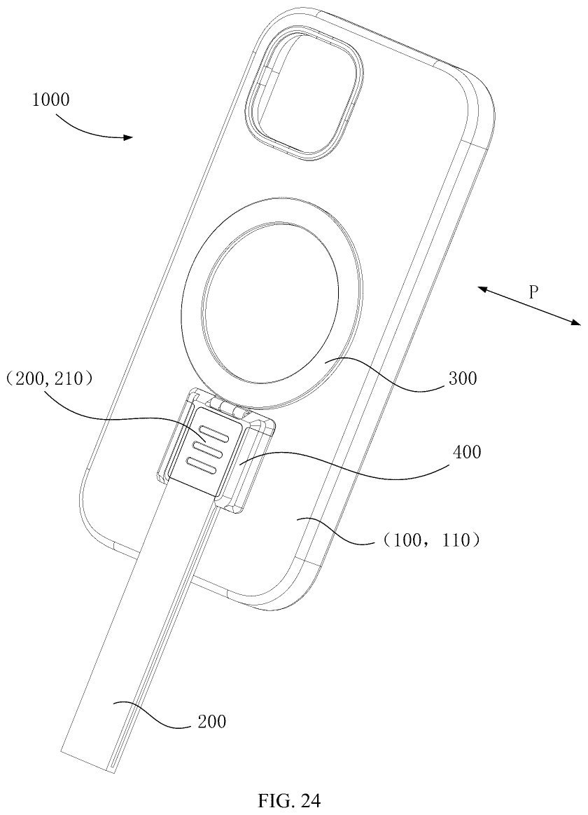

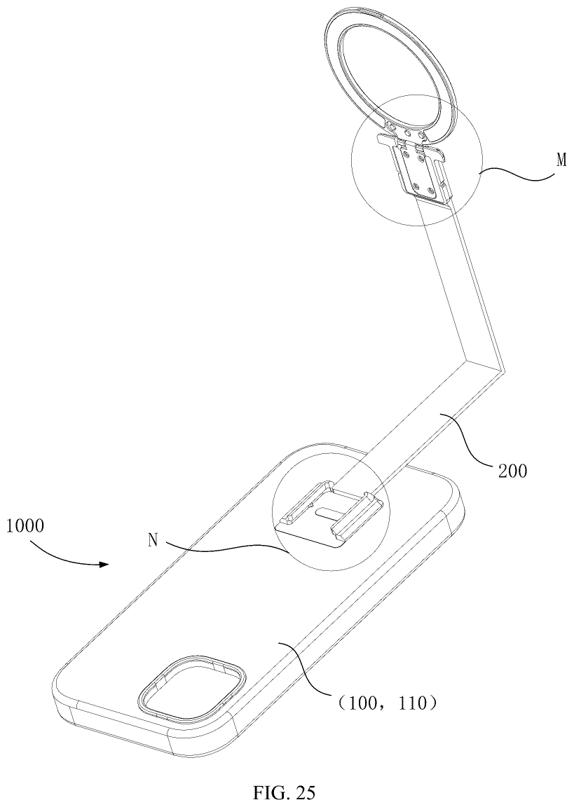

Referring to FIGS. 24-27, in some embodiments, the connecting base 400 includes a first hard connecting block 440 and a second hard connecting block 450, the first hard connecting block 440 is connected with the second hard connecting block 450, the second end portion 220 of the connecting strap 200 is clamped between the first hard connecting block 440 and the second hard connecting block 450, which enables good connection stability between the second end portion 220 of the connecting strap 200 and the connecting base 400.

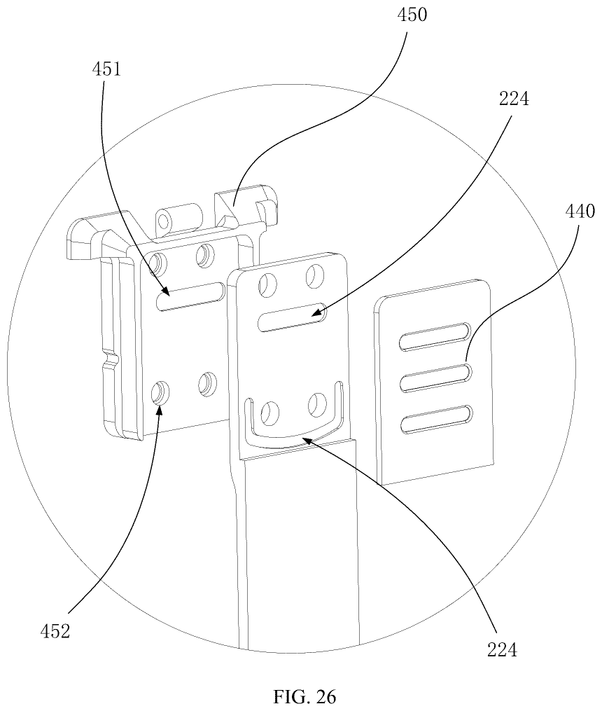

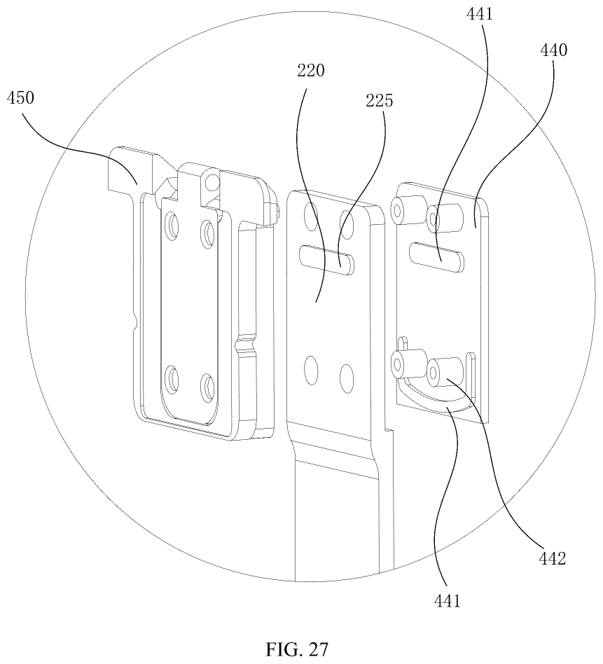

Referring to FIGS. 26-27, in some embodiments, the protective case 1000 further includes a first protruding portion 441 and a first recessed portion 224, one of the first protruding portion 441 and the first recessed portion 224 is disposed on one side of the first hard connecting block 440 facing the second end portion 220 of the connecting strap 200, another one of the first protruding portion 441 and the first recessed portion 224 is disposed on a first side of the second end portion 220 of the connecting strap 200 facing the first hard connecting block 440, the first protruding portion 441 is configured to accommodate into the first recessed portion 224. In this way, connection stability between the first hard connecting block 440 and the second end portion 220 of the connecting strap 200 is enhanced by providing the first protruding portion 441 and the first recessed portion 224.

Referring to FIG. 27, in some embodiments, the protective case 1000 further includes a second protruding portion 225 and a second recessed portion 451, one of the second protruding portion 225 and the second recessed portion 451 is disposed on one side of the second hard connecting portion 450 facing the second end portion 220 of the connecting strap 200, another one of the second protruding portion 225 and the second recessed portion 451 is disposed on a second side of the second end portion 220 of the connecting strap 200 facing the second hard connecting block 450, the second protruding portion 225 is configured to accommodate into the second recessed portion 451. In this way, connection stability between the second hard connecting block 450 and the second end portion 220 of the connecting strap 200 is enhanced by providing the second protruding portion 225 and the first recessed portion 451.

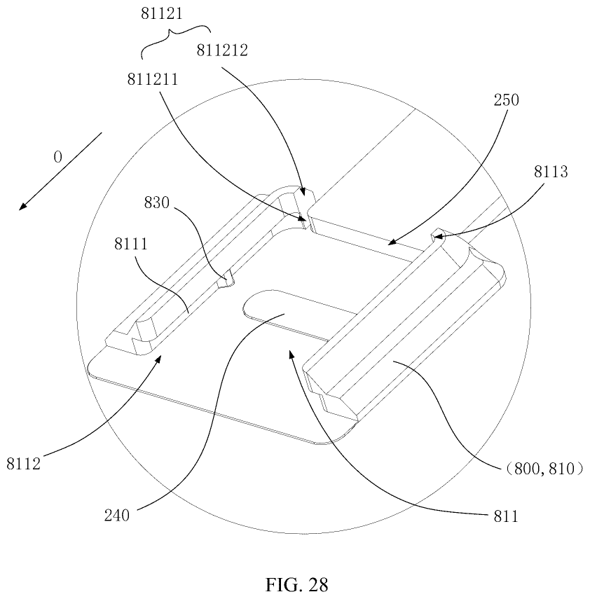

Referring to FIG. 28, in some embodiments, a second inserting groove 811 is defined on the rear portion 110 of the main body 100 for allowing the connecting base 400 to insert.

The embodiment provides a specific implementation where the connecting base 400 is detachably connected to the rear portion 110 of the main body 100, specifically, when the connecting base 400 is detached from the rear portion 110 of the main body 100, the connecting base 400 is pulled out of the second inserting groove 811, and it is only necessary to insert the connecting base 400 into the second inserting groove 811 to mount the connecting base 400 back to the rear portion 110 of the main body 100, which is very convenient.

In some embodiments, the connecting base 400 is detachably connected to the rear portion 110 of the main body 100 through magnetic attraction. Specifically, when the connecting base 400 needs to be detached from the rear portion 110 of the main body 100, it is only necessary to apply a force to drive the connecting base 400 away from the rear portion 110 of the main body 100; when the connecting base 400 is intended to be mounted back to the rear portion 110 of the main body 100, it is only necessary to place the connecting base 400 on the rear portion 110 of the main body 100, and the connecting base 400 is attracted to the rear portion 110 of the main body 100 through a magnetic attraction force, which is very convenient.

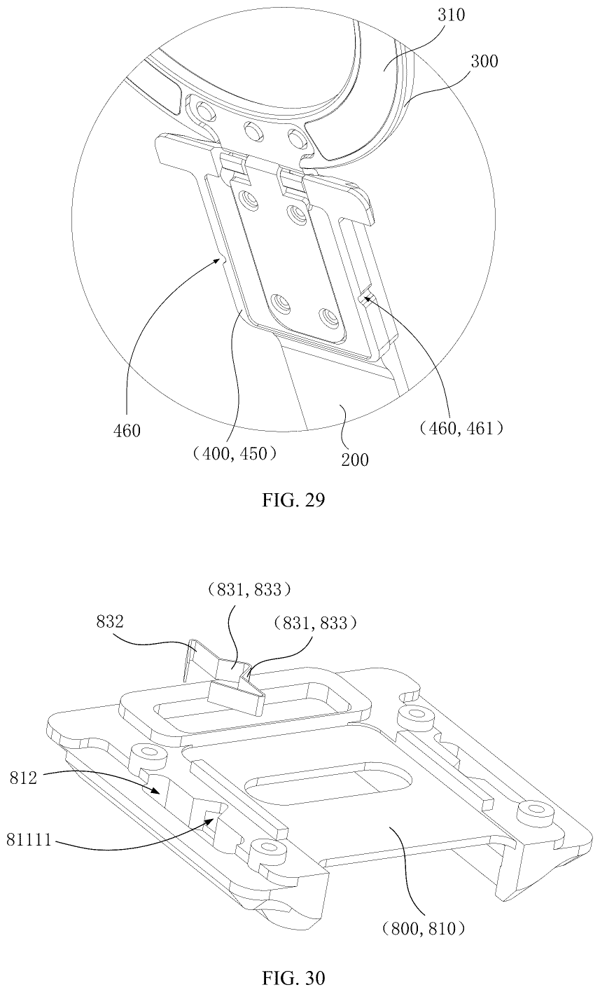

Referring to FIGS. 28-29, in some embodiments, the protective case 1000 further includes at least one elastic clamping block 830 and at least one clamping groove 460, one of the at least one elastic clamping block 830 and the at least one clamping groove 460 is disposed on a groove wall 8111 of the second inserting groove 811, and another one of the at least one elastic clamping block 830 and the at least one clamping groove 460 is disposed on the connecting base 400, the at least one elastic clamping block 830 is matched with the at least one clamping groove 460.

By implementing the embodiment, after the connecting base 400 is inserted into the second inserting groove 811, the at least one elastic clamping block 830 is clamped in the at least one clamping groove 460, so that the connecting base 400 is limited by the at least one elastic clamping block 830 and the at least one clamping groove 460, in this way, the connecting base 400 is more stably accommodated in the second inserting groove 811 and is avoided from being affected by external force to easily separate from the second inserting groove 811, thereby enabling excellent user experience.

Referring to FIGS. 28-30, in a specific embodiment, the at least one elastic clamping block 830 includes two side walls 831 oppositely disposed along a groove opening 8112 of the second inserting groove 811, and the two side walls 831 gradually come closer in a direction where the at least one elastic clamping block 830 faces a groove bottom 461 of the at least one clamping groove 460.

Specifically, when the connecting base 400 enters the second inserting groove 811, one of the two side walls 831 of the at least one elastic clamping block 830 is squeezed, since the two side walls 831 gradually come closer in the direction where the at least one elastic clamping block 830 faces the groove bottom 461 of the at least one clamping groove 460, as long as the connecting base 400 provides sufficient force for the at least one elastic clamping block 830 to deform and store energy, the at least one elastic clamping block 830 is stressed to deform and store energy, so that the connecting base 400 smoothly enter the second inserting groove 811; when the connecting base 400 is pulled out from the second inserting groove 811, another one of the two side walls 831 of the at least one elastic clamping block 830 is squeezed, since the two side walls 831 gradually come closer in the direction where the at least one elastic clamping block 830 faces the groove bottom 461 of the at least one clamping groove 460, as long as the connecting base 400 provides the sufficient force for the at least one elastic clamping block 830 to deform and store energy, the at least one elastic clamping block 830 is stressed to deform and store energy, so that the connecting base 400 is smoothly separated from the second inserting groove 811.

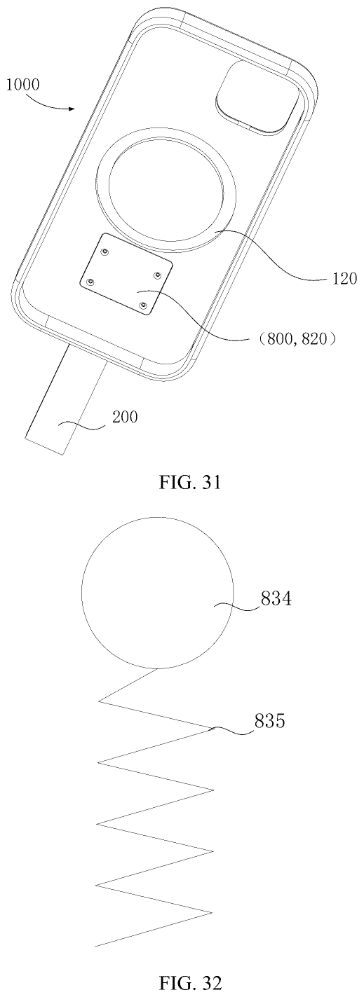

Referring to FIGS. 28 and 31, in some embodiments, a connecting assembly 800 is disposed on the rear portion 110 of the main body 100, the connecting assembly 800 includes a third hard connecting block 810 and a fourth hard connecting block 820, the third hard connecting block 810 is connected with the fourth connecting block 820, and the first end portion 210 of the connecting strap 200 is clamped between the third hard connecting block 810 and the fourth hard connecting block 820. In this way, good connection stability between the first end portion 210 of the connecting strap 200 and the connecting assembly 800 is enabled.

Referring to FIGS. 28-30, in some embodiments, the second inserting groove 811 is defined on the third hard connecting block 810, at least one mounting groove 812 is defined on the third hard connecting block 810, at least one second opening 81111 is defined on the groove wall 8111 of the second inserting groove 811, the at least one second opening 81111 is communicated with the at least one mounting groove 812, the at least one elastic clamping block 830 includes a second, mounting portion 832 and a clamping portion 833, the second mounting portion 832 is limited and disposed in the at least one second mounting groove 812, the clamping portion 833 is inserted into the second inserting groove 811 through the second opening 81111, and the two side walls 831 of the at least one elastic clamping block 830 are both disposed on the clamping portion 833.

Referring to FIG. 32, in some embodiments, the at least one elastic clamping block 830 includes an embedded block 834 and a spring 835, the embedded block 834 is a sphere or a hemisphere, the spring 835 is disposed at one side of the at least one elastic clamping block 830 facing away from the at least one clamping groove 460, so that when the at least one clamping groove 460 moves to match with the at least one elastic clamping block 830, the spring 835 drives the at least one elastic clamping block 830 to clamp into the at least one clamping groove 460.

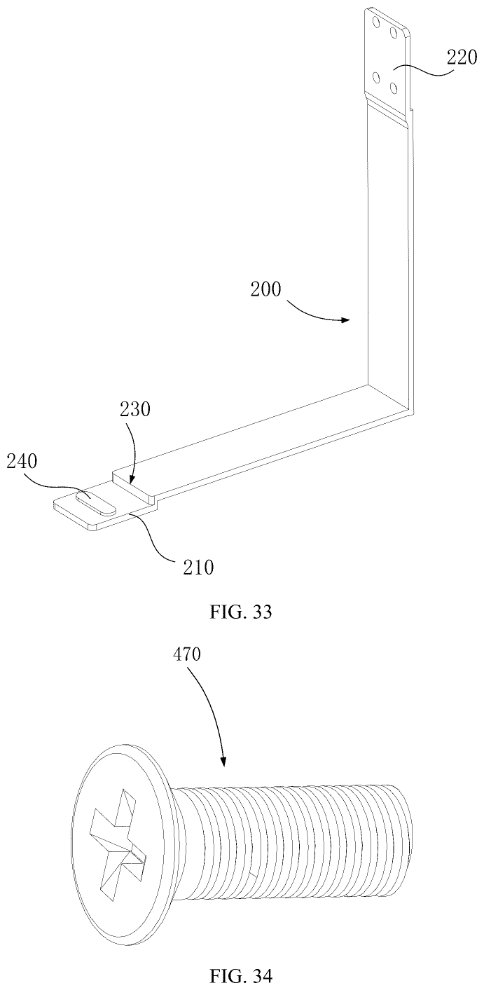

Referring to FIGS. 28 and 33, in some embodiments, a second positioning friction block 240 is disposed on the groove wall 8111 of the second inserting groove 811, and the second positioning friction block 240 is configured to abut against the connecting base 400. In this way, after the connecting base 400 is inserted into the second inserting groove 811, the connecting base 400 is in contact with the second positioning friction block 240, and the second positioning friction block 240 provides a positioning friction force for the connecting base 400, in this way, the connecting base 400 is more stably accommodated in the second inserting groove 811 and is avoided from being affected by external force to easily separate from the second inserting groove 811, thereby enabling the excellent user experience.

Referring to FIG. 33, in a specific embodiment, the second positioning friction block 240 and the first end portion 210 of the connecting strap 200 is integrally formed. In this way, the number of parts is reduced, thereby effectively reducing the production and assembly costs.

Referring to FIGS. 26-27 and 34, in some embodiments, the connecting base 400 further includes at least one screw 470, at least one inner threaded column 442 is disposed on one side of the first hard connecting block 440 facing the second hard connecting block 450, the at least one inner threaded column 442 passes through the second end portion 220 of the connecting strap 200, at least one mounting hole 452 is defined on the second hard connecting bock 450, and the at least one screw 470 passes through the at least one mounting hole 452 and the at least one inner threaded column 442 for fixedly connecting the first hard connecting block 440 and the second hard connecting block 450.

Threaded connection enables reliable connection strength, which is also simple in structure and low in cost, so the first hard connecting block 440 and the second hard connecting block 450 in the embodiment are connected by the at least one screw 470. In some embodiments, a connection manner of the third hard connecting block 810 and the fourth hard connecting block 820 is the same as a connection manner of the first hard connecting block 440 and the second hard connecting block 450 in the embodiment, which is repeated herein.

Referring to FIGS. 26-27, in order to increase connection stability between the first hard connecting block 440 and the second hard connecting block 450, in a specific embodiment, four inner threaded columns 442 are provided, the four inner threaded columns 442 are arranged on the one side of the first hard connecting block 440 facing the second hard connecting block 450 in a matrix manner, four mounting holes 452 and four screws 470 are further provided according to the four inner threaded columns 442.

Referring to FIGS. 24 and 28, in some embodiments, an orientation (O direction shown in FIG. 28) of the groove opening 8112 of the second inserting groove 811 is perpendicular to a thickness direction (P direction shown in FIG. 24) of the main body 100. A second through opening 81121 is defined at a groove bottom 8113 of the second inserting groove 811 for the connecting strap 200 to pass through.

Specifically, the connecting base 400 and the second inserting groove 811 need to have sufficient insertion depth, to enable strong insertion stability, and if the orientation of the groove opening 8112 of the second inserting groove 8112 is the same as the thickness direction of the main body 100, a thickness of the main body 100 is relatively large, thereby resulting poor user experience. In order to make the main body 100 thinner, the orientation of the groove opening 8112 of the second inserting groove 811 in the embodiment is perpendicular to the thickness direction of the main body 100.

Referring to FIG. 28, in some embodiments, the second through opening 81121 includes a first area 811211 and a second area 811212, the first area 811211 is disposed at one side of the second area 811212 close to the rear portion 110 of the main body 100. A first middle portion of the connecting strap 200 adjacent to the second end portion 220 of the connecting strap 200 passes through the second area 811212, a limiting step 250 is disposed at a second middle portion of the connecting strap 200 adjacent to the first end portion 210 of the connecting strap 200, the limiting step 250 is disposed at the first area 811211 and is configured to limit the connecting base 400. In this way, after the connecting base 400 moves to an end portion thereof and enters the second inserting groove 811, the connecting base 400 is blocked by the limiting step 250, and when the user mount the connecting base 400, it is only necessary to push the connecting base 400 to abut against the limiting step 250, which is very convenient.

Referring to FIGS. 29-30, in some embodiments, a first magnetic ring 310 is disposed on the supporting component 300, a second magnetic ring 120 is disposed on the rear portion 110 of the main body 100, and the first magnetic ring 310 is attracted to the second magnetic ring 120.

By implementing the embodiment, when the supporting component 300 needs to be accommodated, the supporting component 300 is attracted to the rear portion 10 of the main body 100 by the second magnetic ring 120, thereby preventing the supporting component 300 from rotating and opening due to influence of external force. In addition, since the connecting base 400 is connected to the supporting component 300, connection stability between the connecting base 400 and the main body 100 is also stronger, the connecting base 400 may not be easily separated from the main body 100 by external force, thereby enabling the excellent user experience.

In some embodiment, the protective case further includes a reflective mirror 900.

Specifically, the user may use the reflective mirror 900 to check appearance and see whether makeup needs to be adjusted, which provides better user experience for a female user.

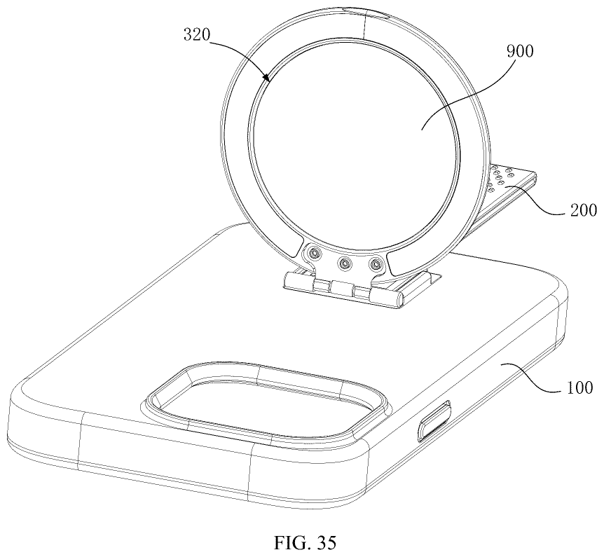

Referring to FIG. 35, in some embodiments, the reflective mirror 900 is disposed on one side of the supporting component 300 facing the rear portion 110 of the main body 100.

When the user needs to use the reflective mirror 900, the supporting component 300 is rotated to expose the reflective mirror 900. When the reflective mirror 900 does not need to be used, the supporting component 300 is reversely rotated to shield the reflective mirror 900. Specifically, since the reflective mirror 900 is reflective and is prone to collecting fingerprints, some users find the protective case 1000 less aesthetically pleasing when the reflective mirror 900 is exposed on the rear portion 110 of the main body 100. By implementing the embodiment, the reflective mirror 900 is exposed only when the reflective mirror 900 needs to be used, and the reflective mirror 900 is shielded when the reflective mirror 900 is not needed, thereby enabling an attractive appearance of the protective case 1000.

Referring to FIG. 35, in a specific embodiment, a third mounting groove 320 is further defined on the one side of the supporting component 300 facing the rear portion 110 of the main body 100, the reflective mirror 900 is disposed in the third mounting groove 310.

Specifically, the reflective mirror 900 needs to be assembled at a preset position on the supporting component 300, and when the third mounting groove 320 is not provided, an operator may easily misalign the reflective mirror 900 during assembly, leading to poor product consistency. By implementing the embodiment, the third mounting groove provides a clear mounting position for the operator, which not only facilitates mounting of the reflective mirror 900, but also ensures good product consistency in manufactured products.

It should be understood that the above embodiments are only used to illustrate technical solutions of the present disclosure, rather than limiting the present disclosure, and for those who skilled in the art, the technical solutions described in the above embodiments may be modified, or some of the technical features may be equivalently replaced; and all these modifications and replacements shall fall within a protection scope of appended claims of the present disclosure.

What is claimed is:

1. A protective case, comprising:
a main body;
a connecting strap; and
a supporting component;
wherein the connecting strap is made by a flexible material, the connecting strap comprises a first end portion and a second end portion, the first end portion of the connecting strap is disposed opposite to the second end portion of the connecting strap, and the first end portion of the connecting strap is connected to the main body; and
the supporting component is disposed on a rear portion of the main body, the second end portion of the connecting strap is rotatably connected to the supporting component to enable the connecting strap to enclose to define an accommodating space and to enable the supporting component to rotate with respect to the rear portion of the main body and to support the rear portion of the main body.

2. The protective case according to claim 1, wherein the protective case further comprises a connecting base, the supporting component is disposed on the rear portion of the main body through the connecting base, the supporting component is rotatably connected to the second end portion of the connecting strap through the connecting base, the connecting base is detachably connected to the rear portion of the main body.

3. The protective case according to claim 2, wherein the second end portion of the protective case comprises two first connecting sections, the connecting base is clamped between the two first connecting sections.

4. The protective case according to claim 3, wherein at least one first through opening is defined on the connecting base, the second end portion of the connecting strap further comprises at least one connecting rib, the at least one connecting rib passes through the at least one through opening and is connected to the two first connecting sections.

5. The protective case according to claim 2, wherein the protective case further comprises a mounting block, the first end portion of the connecting strap is connected to the mounting block, a groove is defined on one side of the main body facing opposite to the rear portion of the main body, a first opening is defined on a bottom of the groove;
the mounting block comprises a first mounting portion and at least one inserting portion, a contour of the first mounting portion is matched with a contour of the groove, and the contour of the first mounting portion is greater than a contour of the first opening, so that the first mounting portion is clamped at the groove; and
the at least one inserting portion is connected to one side of the first mounting portion facing the first opening, the at least one inserting portion defines a first inserting groove at a portion thereof where the portion of the at least one inserting portion protrudes out of the first opening, and the first inserting groove allows the connecting base to insert.

6. The protective case according to claim 5, wherein a width of the mounting block is less than a diagonal length of the first opening, and a width of the supporting component is greater than the diagonal length of the first opening.

7. The protective case according to claim 2, wherein the protective case further comprises a slot structure and an inserting structure, one of the slot structure and the inserting structure is disposed on the rear portion of the main body, and another one of the slot structure and the inserting structure are disposed on the connecting base; and
the inserting structure is inserted into the slot structure in a first direction for detachably connecting the connecting base to the rear portion of the main body.

8. The protective case according to claim 7, wherein the protective case further comprises a first positioning friction block, the connecting base comprises a first surface perpendicular to a second direction, the second direction is perpendicular to the first direction; and
the first positioning friction block is disposed on the first surface and is configured to provide a positioning friction force when the inserting structure is inserted into the slot structure.

9. The protective case according to claim 8, wherein the inserting structure is disposed on the rear portion of the main body, the inserting structure comprises two inserting blocks extending in the first direction, the two inserting blocks are spaced apart in a third direction, the first end portion of the connecting strap is disposed between the two inserting blocks, the third direction is perpendicular to the first direction and the second direction; and
the slot structure comprises two form-fitting slots respectively matched with the two inserting blocks, a first mounting groove is further defined on the first surface, the first mounting groove is defined between the two form-fitting slots, the first positioning friction block is disposed in the first mounting groove, so that the first positioning friction block is disposed opposite to the first end portion of the connecting strap in the second direction.

10. The protective case according to claim 2, wherein the connecting base comprises a first hard connecting block and a second hard connecting block, the first hard connecting block is connected with the second hard connecting block, the second end portion of the connecting strap is clamped between the first hard connecting block and the second hard connecting block.

11. The protective case according to claim 10, wherein the protective case further comprises a first protruding portion and a first recessed portion, one of the first protruding portion and the first recessed portion is disposed on one side of the first hard connecting block facing the second end portion of the connecting strap, another one of the first protruding portion and the first recessed portion is disposed on a first side of the second end portion of the connecting strap facing the first hard connecting block, the first protruding portion is configured to accommodate into the first recessed portion; and/or
the protective case further comprises a second protruding portion and a second recessed portion, one of the second protruding portion and the second recessed portion is disposed on one side of the second hard connecting portion facing the second end portion of the connecting strap, another one of the second protruding portion and the second recessed portion is disposed on a second side of the second end portion of the connecting strap facing the second hard connecting block, the second protruding portion is configured to accommodate into the second recessed portion.

12. The protective case according to claim 10, wherein a second inserting groove is defined on the rear portion of the main body for allowing the connecting base to insert.

13. The protective case according to claim 12, wherein the protective case further comprises at least one elastic clamping block and at least one clamping groove, one of the at least one elastic clamping block and the at least one clamping groove is disposed on a groove wall of the second inserting groove, and another one of the at least one elastic clamping block and the at least one clamping groove is disposed on the connecting base, the at least one elastic clamping block is matched with the at least one clamping groove; and/or
a second positioning friction block is disposed on the groove wall of the second inserting groove, and the second positioning friction block is configured to abut against the connecting base.

14. The protective case according to claim 13, wherein the at least one elastic clamping block comprises two side walls oppositely disposed along a groove opening of the second inserting groove, and the two side walls gradually come closer in a direction where the at least one elastic clamping block faces a groove bottom of the at least one clamping groove.

15. The protective case according to claim 10, wherein the connecting base further comprises at least one screw, at least one inner threaded column is disposed on one side of the first hard connecting block facing the second hard connecting block, the at least one inner threaded column passes through the second end portion of the connecting strap, at least one mounting hole is defined on the second hard connecting bock, and the at least one screw passes through the at least one mounting hole and the at least one inner threaded column for fixedly connecting the first hard connecting block and the second hard connecting block.

16. The protective case according to claim 12, wherein an orientation of the groove opening of the second inserting groove is perpendicular to a thickness direction of the main body; and
a second through opening is defined at a groove bottom of the second inserting groove for the connecting strap to pass through.

17. The protective case according to claim 16, wherein the second through opening comprises a first area and a second area, the first area is disposed at one side of the second area close to the rear portion of the main body;
a first middle portion of the connecting strap adjacent to the second end portion of the connecting strap passes through the second area, a limiting step is disposed at a second middle portion of the connecting strap adjacent to the first end portion of the connecting strap, the limiting step is disposed at the first area and is configured to limit the connecting base.

18. The protective case according to claim 10, wherein the protective case further comprises a connecting assembly, the connecting assembly is disposed on the rear portion of the main body, the connecting assembly comprises a third hard connecting block and a fourth hard connecting block, the third hard connecting block is connected with the fourth connecting block, and the first end portion of the connecting strap is clamped between the third hard connecting block and the fourth hard connecting block.

19. The protective case according to claim 1, wherein a first magnetic ring is disposed on the supporting component, a second magnetic ring is disposed on the rear portion of the main body, and the first magnetic ring is attracted to the second magnetic ring.

20. The protective case according to claim 1, the protective case further comprises a reflective mirror, the reflective mirror is disposed on one side of the supporting component facing the rear portion of the main body.
